(19) United States
(12) Patent Application Publication
(10) Pub. No.: US 2026/0037336 A1
(43) Pub. Date: Feb. 5, 2026

(54) Big Data processing platform and method

(71) Applicants: Daniel Jaye, Wintergarden, FL (US); Sakthi Priyan Hari Krishnan, Chennai (IN); Sudheer Pendyala, Chennai (IN); Sundara Raghavan Sankaran, Chennai (IN)

(72) Inventors: Daniel Jaye, Wintergarden, FL (US); Sakthi Priyan Hari Krishnan, Chennai (IN); Sudheer Pendyala, Chennai (IN); Sundara Raghavan Sankaran, Chennai (IN)

(21) Appl. No.: 19/286,313

(22) Filed: Jul. 31, 2025

(30) Foreign Application Priority Data
Aug. 1, 2024 (IN) 202441058341

(51) Int. Cl. G06F 9/50; G06F 16/22; G06F 16/2458

(52) U.S. Cl. CPC G06F 9/5077; G06F 16/221; G06F 16/2477

(57) ABSTRACT

A highly efficient, scalable, and adaptable framework suitable for modern Big Data processing challenges in cloud-based environments. The framework preferably leverages a scale-up before scale-out paradigm that prioritizes scaling up individual nodes (e.g., with high-core-count processors) before scaling out across multiple nodes. In addition, preferably the framework moves data to compute nodes, e.g., utilizing high-bandwidth cloud storage networks for efficient data transfer. Further, the framework preferably employs specialized primitives optimized for specific Big Data processing tasks, particularly for collations, sorts, and shuffles. Finally, framework utilizes optimized libraries for a small number of file formats.

### BACKGROUND

Since widespread consumer adoption of the internet over 30 years ago, there has been an unprecedented increase in data volume and complexity. Commercial applications are increasingly expected to efficiently process and query data from massive datasets, often involving complex operations in conjunction with very large graph data structures. This necessitates the development of advanced data processing techniques that can handle high volumes of event data per day, referenced over long periods of time in conjunction with very large identity graphs and high-dimensional data to provide near real-time insights, all while maintaining interoperability with mainstream cloud data services.

Big Data primarily refers to data sets that are too large or complex to be dealt with by traditional data-processing application software. So-called “Big Data” technologies, popularized by Apache Hadoop and later Apache Spark, owe their existence to early papers from Google describing the Google File System and the MapReduce computing platform. These papers established four fundamental design principles for Big Data that have survived to this day: 1) moving code (compute) to data, 2) scale out on commodity processors, 3) structuring compute using minimalist primitives, and 4) leverage pluggable file formats. While mainstream Big Data processing solutions based on the above-mentioned technologies provide significant advantages, they have limitations. For example, while the specifics of a customer's data sets and algorithms are unique to them, there is a common processing operation that makes running the algorithms difficult. Specifically, the large event streams need to be grouped—by subject keys—say, a device identifier in an IOT network—and at the same time joined with the master data of those subjects. At tens of billions of events per day, this collating join takes time, is unreliable (i.e., crashes often), and is very expensive.

Another well-known problem involves data aggregation. In particular, Spark and Hadoop share a legacy of “pluggability” for file formats. Different inputs and the various outputs can, in theory, all have different formats in these systems. Under the assumption of pluggability, existing approaches are forced into a pattern of decoding and re-encoding all the data they process. This is computationally expensive, and it also produces a large number of small objects along the way, exerting pressure on garbage collection resources.

More generally, Big Data processing costs are dominated by non-linear operations, such as reducers, shuffling and sorting. Known Big Data solutions that rely on old assumptions (scale-out, moving compute to data, open, pluggable file formats and minimalist primitives) do not provide a reliable, cost-effective solution to these and other data processing problems.

### SUMMARY

This disclosure provides for a highly efficient, scalable, and adaptable framework suitable for modern big data processing challenges in cloud-based environments. More specifically, this disclosure provides a Big Data processing framework that inverts traditional principles to achieve superior performance. In particular, as opposed to traditional scale-out on commodity processors, the framework herein preferably leverages a scale-up before scale-out paradigm that prioritizes scaling up individual nodes (e.g., with high-core-count processors) before scaling out across multiple nodes. In addition, and as opposed to moving compute to the data as in the past, preferably the framework moves data to compute nodes, e.g., utilizing high-bandwidth cloud storage networks for efficient data transfer. Further, and instead of relying on minimalist primitives, the framework preferably employs specialized primitives (operators) that are optimized for specific Big Data processing tasks, particularly for collations, sorts, and shuffles. Finally, and in lieu of open, pluggable file formats, preferably the framework instead utilizes optimized custom-built libraries for a small number of file formats (namely, Avro for row-based, and Parquet for columnar), with those libraries implemented for lightweight, multi-threaded, efficient parallel Input/Output (I/O). By leveraging such hardware capabilities, optimized file formats, and specialized processing techniques, this framework significantly improves processing speed and resource efficiency.

The foregoing has outlined some of the more pertinent features of the disclosed subject matter. These features should be construed to be merely illustrative. Many other beneficial results can be attained by applying the disclosed subject matter in a different manner or by modifying the subject matter, as will be described below.

### BRIEF DESCRIPTION OF DRAWINGS

For a more complete understanding of the subject matter herein and the advantages thereof, reference is now made to the following descriptions taken in conjunction with the accompanying drawings, in which:

FIG. 1 depicts a representative Big Data processing platform architecture in which the techniques of this disclosure may be practiced;

FIG. 2 depicts further details of a representative data processing engine in the framework; and

FIG. 3 depicts an analytics engine for use in or in association with the framework; and

FIG. 4 depicts a representative cloud compute infrastructure on which the platform (or components thereof) may be implemented.

### DETAILED DESCRIPTION

The processing framework herein is not limited to any particular type of Big Data. Big Data typically refers to the notion of event-level data processing (e.g., for a platform user/customer), where the event streams processed can number as high as tens of billions of events (per user customer), and which often need to be joined against master data of hundreds of millions of records.

Traditionally, data is organized in row or column formats. In a row format, the data is organized by record, with all data associated with a particular record stored together. The data of a row is arranged such that the last column of the row is stored next to the first column entry of a next data row. In a column (or columnar) format, the values of each table column (field) are stored next to each other. Like items are grouped and stored next to one another. In a columnar format, within fields read-in order is maintained, which preserves the ability to link data to records. Known file formats for Big Data include Apache Avro for row-oriented data, and Apache Parquet for column-oriented data. These two formats are leveraged by the platform here. Avro is an open source project that provides data serialization and data exchange services for Apache Hadoop. It provides rich data structures, a compact binary format, and a container file for persistent data. Apache Parquet is an open source, column-oriented data file format designed for efficient data storage and retrieval. It provides high performance compression and encoding schemes to handle complex data in bulk and is supported in many programming language and analytics tools. Apache Parquet is implemented using a record-shredding and assembly algorithm, which accommodates the complex data structures that can be used to store data. The values in each column are stored in contiguous memory locations, providing the following benefits: column-wise compression is efficient in storage space, encoding and compression techniques specific to the type of data in each column can be used, and queries that fetch specific column values need not read the entire row, thus improving performance. The Avro and Parquet formats are tuned for high-throughput data access, minimal serialization overhead, and efficient I/O pattern.

Avro encoding is composable. Thus, adding a field to a record in Avro does not affect the encoding of the other fields. The new field is encoded and the resultant byte array is inserted in an appropriate position. Avro has other desirable properties that make it very useful for Big Data processing. For example, encoding of concatenated Avro arrays is obtained cheaply by concatenating their encoded forms after removing the last byte of the encoding of the first array. Larger Avro data files can be constructed form smaller data files by just concatenating them after removing just the headers of the second and the following files. This is particularly efficient because the operation can be performed while the data is in a cloud data store (i.e., without taking the data out of that storage). These features enable decoding operations with respect to Avro data to be “lazy,” in the sense that the encoded data can be decoded/re-encoded directly, thereby saving computational (CPU) expense. In addition, garbage collection is simplified because (instead of dealing with large numbers of language-native objects (in the decoded form)), the collector only deals with a small number of byte arrays. As will be described below, the processing approach herein preferably leverages both Avro data files, as well as Avro index files, which themselves are Avro files that store only the key fields of the records and their positions within the main Avro files. Scanning Avro index files is highly efficient in terms of CPU and memory.

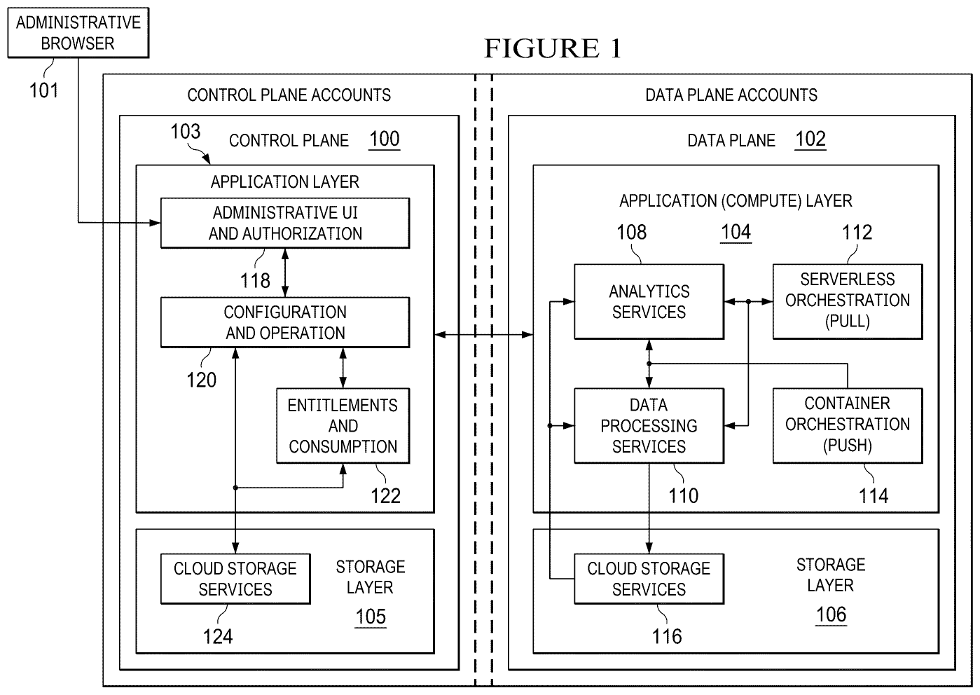

FIG. 1 depicts a representative implementation, namely, a platform (sometimes referred to herein as a framework) for processing Big Data. In this non-limiting example, the platform is configured as a marketing data platform to solve canonical problems in data processing for advertising and marketing use cases. This platform addresses the requirement to be able to efficiently organize (i.e., collate) large volumes of data subject event data by high cardinality data subject identifiers, e.g., to support audience-centric analytics and decisioning. To this end, FIG. 1 depicts a representative architecture that comprises a control plane 100, and a data plane 102. The data plane 102 comprises an application (compute) layer 104, and a storage layer 106. The compute layer 104 comprises analytics services 108, and data processing services 110. The analytics services 108 leverage serverless orchestration, which is pull-based, and the data processing services 110 leverage container orchestration, which is push-based. As will be described in further detail below, both the analytics and data processing services interoperate with cloud storage services 116 in the storage layer 106. The control plane 100 comprises an application layer 103, and a storage layer 105. The control plane 100 is network-accessible via a browser 101. The application layer 103 in the control plane 100 comprises an administrative UI and authentication component 118, a configuration and operation component 120, and an entitlements and consumption component 122. The storage layer 105 of the control plane includes cloud storage services 124. The storage layers 105 and 106 may be the same or distinct. The control plane 100 comprises a network-accessible portal and Application Programming Interfaces (APIs) as needed. The storage layer 106 typically comprises one or more datamarts and a lakehouse 122. The lakehouse is a system of record for data that has been gathered, harmonized and collated. Preferably, the lakehouse stores data in an immutable manner and at the same granularity as the source data, but in a harmonized form so that it is ready to use. Preferably, data in the lakehouse is organized around data subjects and optimized for the data operations and use cases. A datamart provides access to the data, e.g., for Online Analytical Processing (OLAP) use cases, in an efficient form. In a typical use case, the data mart stores data in Apache Parquet, a column-oriented format for Big Data and optimized for serverless queries.

Preferably, the framework leverages Go (also known as GoLang), a high-level general purpose programming language that is statically typed and compiled, and a high performant-GoLang engine that operates according to this language. GoLang provides a modern programming language with lightweight thread support. Go code is converted into machine code before execution, resulting in faster runtime performance. Its syntax is concise and similar to C, making it easy to learn for developers familiar with procedural programming. A core feature of Go is concurrency, which is achieved through constructs referred to as goroutines and channels. Goroutines are lightweight threads managed by Go's runtime, allowing thousands of concurrent tasks to run efficiently. Channels facilitate communication between goroutines, enabling safe data sharing without explicit locking. Goroutines allow for asynchronous I/O without resorting to async/await, callback or futures. Typically, the number of threads in a Go program is the same as the number of cores, and thus thread-switching is avoided. Go has efficient memory management (especially pointers into structs and arrays), which facilitates lazy decode of Avro data. It also provides good cache performance. Go programs are built into a single, compact binary executable.

Generalizing, the framework in FIG. 1 operates in a Platform-as-a-Service (PaaS) manner for any Big Data workload, and irrespective of domain, to process very high volumes of time series data from various sources, namely, (in the marketing application) digital media channels. As noted, this particular field (marketing data) is not intended to be limited. This solution is based on a flexible deployment architecture, allowing data-forward and compute-forward deployment with a low-code developer sandbox which enables a platform which is both customizable and repeatable. The solution preferably also contains or leverages pre-built integrations to third party data vendors as well as a flexible and rich lakehouse schema and efficient API's for analytics and decisioning.

In operation, and referring back to FIG. 1, the data processing services 110 handle the large scale data processing of data ingested into the lakehouse, materializing data marts, and distributing data to downstream applications and datastores. It interoperates with or utilizes Cloud Service Providers (CSPs) such as Amazon AWS, Microsoft® Azure® and Google® Public Cloud, taking advantage of effectively limitless cross-sectional bandwidth of their object stores and handling the complex non-linear data processing (collation, joins, shuffles, sorts, and high cardinality aggregation) typical in marketing Big Data applications. In a representative implementation, the data processing services 110 comprising a data processing engine that runs on Kubernetes clusters on one or more CSPs, and associated worker nodes that access data protection-controlled data operate within multiple deployment models (for example, a provider SOC2-compliant compute environment which isolates client workloads, a vendor's multi-tenant compute environment in their VPC, a dedicated compute environment for an individual brand or secure data sharing partnership in their own VPC, and the like). The data processing engine executes instructions, e.g., customized in a low code solution based on YAML instructions, which may be developed and tested in a sandbox.

The above-described platform supports various types of jobs for ingesting, processing, and analyzing the data. Jobs are the unit of execution for operations on the data lake (the lakehouse) within a service and preferably operate on a per client per channel basis. Data channels are associated with a specific data source with a specific set of credentials. Preferably, these jobs are configured using YAML files that specify parameters for connecting to data sources, transforming data (e.g., making changes to the data while carrying out a mapping), and outputting results.

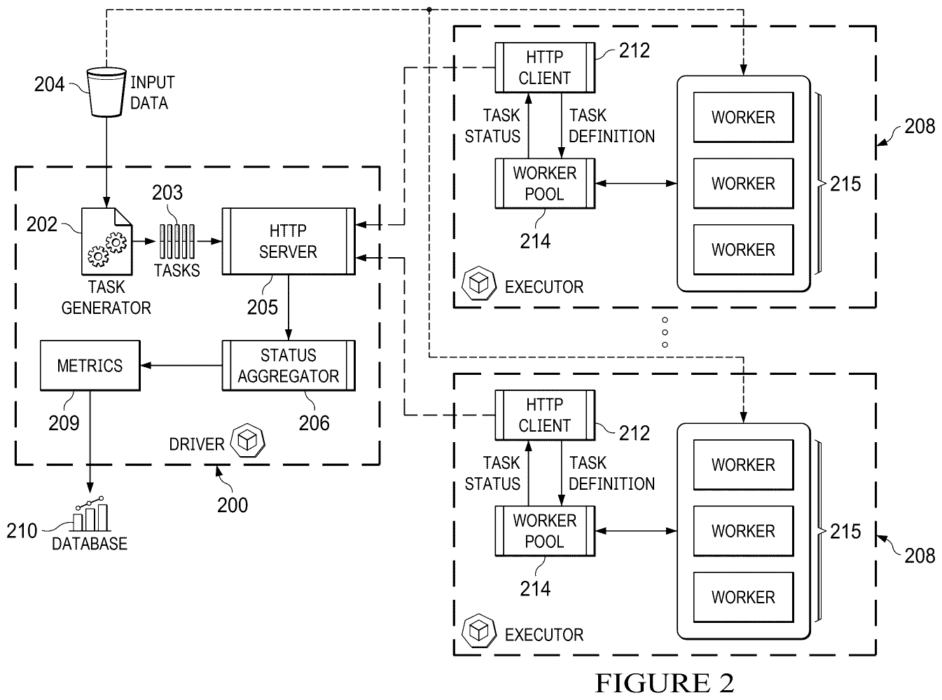

FIG. 2 depicts a representative processing engine architecture, corresponding to the data engine shown in FIG. 1. According to the processing paradigm herein, preferably a job comprises a set of stages that are executed sequentially. Thus, in the usual case, a stage only starts after a previous stage has successfully completed. Stages comprise tasks, and tasks are preferably performed concurrently. The performance of one task does not depend on any other task. The processing engine has three (3) roles: a driver, executors, and workers. The driver generates a processing stage and the tasks within that stage. Executors typically are operating system (OS) processes hosting the workers. Executors are started for each stage separately, which affords the engine flexibility to have different capacities for each stage. Workers are implemented as GoLang goroutines running with the executors. Workers perform the tasks. When an executor finds no tasks for any of its workers, it is shutdown, thereby saving cloud costs. Hooks at the executor-level and worker-level allow common work to be performed at each level once instead of repeating the work for each task. In the processing engine runtime, an executor also can be configured to run on the driver process. The processing engine also exploits the Avro feature of runtime schema handling such that a single application can handle a class of input schemas without any change. The system natively supports fanout. More than one dataset can be written at the same time, and per-fanout transformations and filtering are also supported. The fanout feature also allows the engine to send problematic records of an input dataset into a quarantine file while processing the rest of the records. The engine also supports resource specification at stage-level. The results of each stage and each task within the stage preferably are stored (e.g., in the cloud storage); if a job needs to restart, it skips the work already completed.

The runtime supports one or more plug-ins, such as user-supplied Python code that allows record-level transformations and filtering to be performed. The plug-in protocol is language-agnostic, so the example of Python is not intended to be limiting. To this end, and for each worker, a Python process is configured as a sidecar. The records to be transformed and/or filtered are passed to the Python code over Unix-domain sockets, and the data is transported in Avro format.

FIG. 2 in particular depicts a stage of the processing engine. As noted above, the processing engine comprises driver 200, which drives the stage, and one or more executors 208. The driver 200 acts as a coordinator for the work done by the one or more executors 208, wherein executors are typically implemented as individual compute nodes in a cloud compute cluster. When multiple executors are associated with a driver, this is sometimes referred to herein as a “multi-executor” instantiation. Input data to be processed is depicted at 204. A task generator 202 splits the requisite workload (or “work”) into tasks 203, which are provided (via a task queue not shown) to HTTP server 205. The driver 200 also includes a status aggregator 206, which keeps track of the processing (and results generated) by the executors 208, and a metrics component 209 that tracks and save metrics data in database 210. Each executor 208 has an HTTP client 212 that interoperates with the HTTP server 205 in the driver, requesting processing work and returning results. The HTTP client 212 in the executor 208 provides a task definition (for a task) to a worker pool 214, which then spawns workers 215. The workers 215 are the processes executing tasks on each executor node, and typically there are several workers per virtual core (e.g., an Azure SQL vCore). The workers 215, in a processing loop, pick up a task from the task queue, perform that task, and then put the result in a result queued. A worker 215 shuts down when there are no more tasks in the queue. An executor shuts down when all of its workers 215 shut down. Each of the driver and an executor have an associated storage.

For a typical Big Data operation such as sort-merge joins, the driver is responsible for directing the executors to perform pre-shuffle and post-shuffle operations. The executors run the mapping operations. When an executor demands, the driver passes columnar task-metadata (what operation to perform, on which files and where to produce the output), and the executors send the results of the task back to the driver. The task status aggregator keeps track of the executor results; the results are aggregated, not just merely collected. When all tasks are done, the operation is complete. The executor runs one or more (or any number of) concurrent workers, each of which can work on a task. When an executor does not get a task from the driver and all its workers are free, as noted above it shuts down.

The number and type of the stages that are implemented in the processing engine depends on the data being processed. Typically, multiple stages are required when a shuffle operation is involved. Data is exchanged across stages, preferably via cloud storage as described in more detail below. Task results are persisted, as are stages. Further, the number of executors, or the number of workers per executor may vary, and different stages may have different capacity allocations.

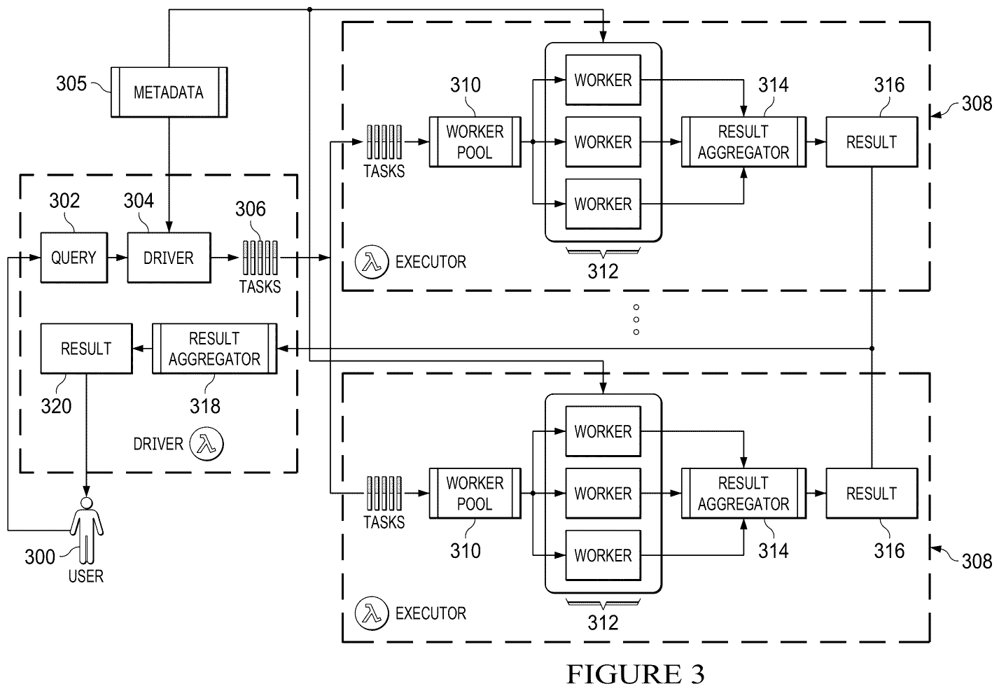

FIG. 3 depicts a representative analytics engine of the analytics services (FIG. 1, 108) for use in or in association with the Big Data framework. This engine preferably leverages the driver and multi-executor functionality described above in FIG. 2. As depicted in this example, here a user 300 enters a query 302. In response, a driver 304 is configured, and which separates the necessary job into a set of tasks 306. The driver 304 configures one or more executors 308, and the tasks 306 are then distributed to the executor(s) 308 for handling. Each executor has a worker pool 310 from which a set of workers 312 are instantiated to perform the a task. The results generated by the workers 312 in a given executor 308 are aggregated into a result 316 by a result aggregator 314, and the executor result(s) 316 are then aggregated into final result 320 by a driver result aggregator 318. The final result is then returned to the user as the response to the query 302. This engine and, in particular the multi-executor framework, is controlled by columnar metadata 305. The analytics engine in FIG. 3 may be implemented on-demand, e.g., on a swarm of serverless lambda functions with built-in restart capabilities.

As noted, and according to this disclosure, the framework leverages several innovative aspects that, together, provide superior performance over prior art techniques. These innovations invert traditional Big Data architecture design principles, leveraging certain hardware capabilities, optimized file formats, and specialized processing techniques to significantly improves processing speed and resource efficiency.

To this end, and as opposed to traditional scale-out on commodity processors, the framework herein leverages a scale-up before scale-out paradigm that prioritizes scaling up individual nodes (e.g., with high-core-count processors) before scaling out across multiple nodes. Scale out provides the support for the multiple executors. In a representative embodiment, the compute resources comprise high-count-core processors (e.g., with between four (4) to four thousand (4000) cores). Thus, the approach herein prioritizes vertical scaling (increasing resources on a single node) before resorting to horizontal scaling (adding more nodes), maximizing resource utilization and reducing complexity. In a preferred embodiment, the platform implements a GoLang engine and which is configured to maximize a single node's multi-core parallelism before extending processing to multiple nodes. The engine exploits the ability of modern servers (e.g., machines with 128-192 vPCUs and up to 48 cores per CPU), taking advantage of near-linear price/performance with added cores. By using high vCore count on a single host, the platform handles large workloads internally before having to distribute work across multiple nodes. GoLang is advantageous for scale-up because of its lightweight concurrency model, which enables efficient parallelism without the overhead of traditional operating system (OS) threads. Goroutines (the lightweight threads of GoLang) consume significantly less memory (e.g., as little as 2 KB per Goroutine versus 1 MB per OS thread) and can scale to handle hundreds of thousands of concurrent tasks. This enables the GoLang engine on a single node to efficiently manage many concurrent I/O and compute operations. Multi-core processors have the further advantage of enabling sharing in-memory of data across workers running on the same processor.

In addition, and as opposed to moving compute to the data, preferably the framework moves data to compute nodes, e.g., utilizing high-bandwidth cloud storage networks for efficient data transfer. This aspect of the framework optimizes data locality, minimizing data movement and reducing network overhead. In this approach, the framework preferably leverages cloud storage (e.g., S3) and accesses that storage directly as opposed to using a file system interface (such as Hadoop). Modern cloud storage facilitates this processing by providing for multi-part upload, range download, server-side assembly of files from parts of other files, pre-fetch and decompression on threads, and strong consistency. In this move-compute-to-the-data paradigm, storage (e.g., cloud object storage like S3, GCS, and the like) is separate from compute, and high-bandwidth networks enable reading of large datasets over the network into compute nodes quickly. Preferably, data is brought to the compute resources on-demand. The Go framework supports this operation by reading directly from cloud storage in parallel (using goroutines to saturate bandwidth). It does not require data to be co-located on a processing node ahead of time-instead, it streams data from the storage cluster to the CPU. This design leverages the fact that cloud object stores usually are the source of truth in many architectures (data lakes) and that elasticity is improved if compute can be spun up independently of storage. Typically, storage requirements grow over time, requirements to process data also vary over time. By separating storage and compute as implemented here, platform resources are optimally used, and cloud storage and compute resources supporting the platform (or leveraged thereby) are also scaled up and down independent of one another. Further, this approach provides cost-savings, as typically network traffic to and from the cloud storage is free as long as the storage is in the same region.

In a preferred embodiment, cloud storage is used as a shuffle medium. In particular, and instead of doing shuffle by moving data from mapper tasks (mappers) to reducer tasks (reducers) directly, mappers send data to the cloud storage and reducers read them from the cloud storage. This is advantageous because, if the job crashes, successfully-completed mapping tasks need not be performed again.

A concrete example involves a shuffle-reduce-join, which is a join strategy used to combine two datasets (like tables) that might be distributed across multiple nodes in a cluster. It involves a shuffle phase, and a reduce (or sort or merge) phase. The shuffle phase is where data is re-distributed across the network, e.g., data with the same join key from both datasets is sent to the same executor or partition. This ensures that all related rows needed for the join operation are located together for efficient processing. Typically, shuffling is an expensive operation as it involves network communication and disk I/O, particularly for large datasets. Once data is shuffled to the correct partitions, the actual join happens locally on each node. In the case of a sort-merge Join, the data within each partition is sorted by the join key. Then, the two sorted datasets within each partition are merged to find matching keys, similar to merging two sorted files. Thus, the shuffle co-locates matching join keys across different partitions and nodes, and the reduce/merge performs the actual join operation locally on the co-located data within each partition. According to this disclosure, preferably, the framework does not perform pre-shuffle and post-shuffle operations concurrently. Instead, it performs pre-shuffle mappings, then the shuffle operation and post-shuffle mappings. As noted above, and in this scenario the cloud storage is used as the shuffle-medium. In other words, after performing the pre-shuffle mappings, the output is sent to the cloud storage, e.g., to a folder corresponding to the reducer based on the key. Once all pre-shuffle mapping is completed, post-shuffle operations are then performed by consuming the contents of the folder(s) corresponding to reducer(s). And, every task's output is persisted. Given the strong consistency guarantees provided by cloud storage, the platform detects that a task has been completed and can then be skipped if the job ever has to restart.

A further advantage of this aspect of the platform (moving compute to the data) is that it avoids having to preload data on compute nodes. In a representative embodiment, the platform scales compute on-demand, e.g., spinning up a 192-vCore machine, streaming a petabyte from S3, then shutting the machine down when done. In this approach, preferably any compute node can access any part of the dataset (e.g., via a fast network), rather than being limited to what resides locally. This is highly advantageous for various use cases, e.g., advertising analytics where data (log files, user datasets) sit in cloud storage and multiple analytical jobs are provisioned to run ad-hoc over the same big files. Preferably, the framework also uses asynchronous prefetch, parallel TCP streams, and other techniques to fully utilize network bandwidth so that a CPU is never starved for data. Natively, storage in the platform is disaggregated, and thus less data duplication and simple recovery are additional benefits. Further, ephemeral compute patterns do not impact performance, as compute nodes can be readily torn down when not needed without losing data.

According to a further aspect, and instead of relying on minimalist primitives, the framework preferably employs specialized primitives (operators) that are optimized for specific Big Data processing tasks, particularly for index shuffling and data manipulation, namely, collations, sorts, and shuffles. More specifically, the platform leverages a rich set of specialized operators tailored to specific data patterns that still handle diverse requirements. Rather than funneling every transformation through generic “map” and “reduce” style tasks, this aspect of the architecture implements operators that exploit known structures in the data, e.g., homogeneous collations, heterogeneous collations (sort-merge joins), sorted record collations (merge operations), graph processing operators, and geospatial operators. Homogeneous collations, involving operations like grouping or aggregating on a single key (analogous to a reduce-by-key), are optimized in a homogeneous manner, meaning that all records of the same key are collated; in addition, optimizations like clustering the reduce-by-key separate from the remainder of a record, and shuffling the remainder of the record without deserializing individual fields, are also provided. Heterogeneous collations (sort-merge joins), e.g., joining two different datasets on a key leverage a primitive that explicitly controls the order of operations for the sort and joins, and merges them in linear time. Sorted record collations use a merge operator primitive that takes advantage of data that is already globally-sorted by some key or timestamp. For example, the merge operator combines presorted logs or performs time-ordered coalescing of events with minimal overhead. The graph processing operator leverages an adjacency list data model in a relaxed cluster topology. The geospatial operator provides for highly-performant polygon to point calculation over very large numbers of records that require direction of movement calculation between subsequent records. Other operators may also be implemented.

Finally, and in lieu of open, pluggable file formats, the framework instead utilizes optimized file format libraries that are custom-built for heap or row-based file formats (i.e., Avro) and columnar file formats (i.e., Parquet). These libraries are implemented in GoLang and thus benefit from its built-in support for lightweight multi-threading. The libraries employ specialized, performance-optimized implementations of Avro for row-based serialization and Parquet for columnar storage. In particular, and for Avro, the platform significantly reduces CPU and memory overhead by eliminating unnecessary data copies and serialization steps. For Avro, records are treated as just two fields: a collation key, and the “rest,” which is a byte-string containing the Avro-encoding of the remaining fields of the record treated. This type of structuring provides significant benefits. In particular, and instead of decoding the entire record, only a pointer to its encoding is passed. While the collation step does not transform any data (transformations happen both before and after collation), collation does require aggregating event records with the same collation key, and joining those records with master-data records. To perform these operations without having to decode and then re-encode data, several Avro properties are leveraged, namely, aggregation and joins. Avro arrays are constructed from the encoded form of their elements without decoding those elements, and an Avro encoding of arrays are concatenated as simple byte strings without being decoded. For joins, the Avro encoding of records are joined to form a wider record also by simple concatenation of their byte strings.

The platform (via these libraries) implements a storage-centric and format-specific paradigm, maximizing performance from Avro and Parquet. To this end, the platform libraries also implement optimizations for nested data structures, together with a “hybrid” storage format that has the best characteristics of Avro and Parquet is also implemented. In particular, this hybrid storage format is a row-columnar format, in which segmented vectors that efficiently encode the dimension columns are stored. Additional optimizations that minimize overhead include zero-copy data reads, zero-serde projections (enabling zero-copy deserializations in Rust), custom buffering, and network-friendly serialization. The result is extremely-efficient storage access and data serialization/deserialization, as well as efficient network data transfer when shuffling or loading data. These custom format libraries are tightly integrated with the runtime using Go's memory model to avoid unnecessary copies, and batching reads to align with cache lines or network MTUs for maximum throughput. The framework's specialized format handling reduces overhead and yields better I/O throughput per core. Its direct control over Avro and Parquet implementations also enables customized optimizations, such as fine-grained compression adjustments and network packet alignment.

The four (4) aspects of the platform mentioned above are preferably all utilized, but this is not a requirement. A Big Data processing platform that implements some or all of these innovations is also within the scope of this disclosure. In a preferred embodiment, the framework includes at least include the capability of scale-up before out on multi-core processing nodes. This latter feature provides the ability to deploy both horizontally and vertically (and with vertical scaling occurring selectively before horizontal scaling) across multiple instances in a cloud compute and storage infrastructure.

The following describes additional details of a representative embodiment of the above-described platform, which is a modular, cloud-native system with flexible deployment architecture that provides both data-forward and compute-forward configurations. The platform comprises several high-level components: a processing engine, a lakehouse, data marts, and an analytics engine. In this embodiment, the processing engine is a Kubernetes-based distributed processing system that handles large-scale data ingestion, transformation, and collation optimized for high-cardinality data subject identifiers. The lakehouse provides a system of record for harmonized data stored in immutable, row-oriented Apache Avro format. The data marts are purpose-build analytic environments in the form of columnar Apache Parquet format, optimized for specific query patterns. The analytics engine is a Lambda/Kubernetes-based distributed analytics system. The nature and type of the data analytics are not a limitation of this disclosure. The platform leverages optimized Golang libraries for scanning and processing Parquet data, together with the above-described hybrid “row-columnar” data format achieved by embedding a custom encoding of all dimension columns into a set of “vector segment” columns. The query processing in the platform is further accelerated through the addition of columnar metadata, which allows bypassing Parquet footer scanning, significantly reducing latency and overhead. In particular, the Parquet columnar metadata combines into a single file the descriptions of the byte offsets of each column within each row group, the min max values, etc., in a single file organized by column. Thus, when the system needs to determine whether column's data is located, it is not necessary to scan footers and parse a large number (e.g., thousands) of partitions. Given that these tables may have often ten thousand (10,000) or more columns, the use of this columnar metadata avoid 99.9% of the metadata overhead, providing significant processing efficiency.

In a first embodiment, e.g., wherein the platform executes on Kubernetes or other container solutions, the processing engine is a core computational component of the platform, and it is designed to handle complex non-linear data processing typical in many Big Data use cases (e.g., marketing technology applications). As described above with respect to FIG. 2, the processing engine provides multi-executor orchestration, dynamically scaling worker nodes (even across cloud service providers) to efficiently process billions of input records on either Kubernetes or cloud functions. The processing engine also provides deployment flexibility, supporting multiple deployment models including vendor multi-tenant environments, or dedicated brand-specific VPCs. The engine enables low-code customization, preferably using YAML-based configuration for customizable, repeatable deployments that can be version-controlled and adapted for specific customer requirements. The engine also is highly extensible, as it supports plug-ins (e.g., in Python and other languages) for complex transformations and table-driven no code data mapping.

In a second embodiment, e.g., wherein the platform executes in association with a serverless operating environment providing swarms of on-demand cloud functions, the analytics engine is a computational component, and it is designed to perform fast analytics on large matrices of data with high speed and efficiency. The serverless architecture of the analytics engine provides additional advantages. In particular, this architecture of the analytics engine is better suited to moving data to compute (e.g., versus known approaches) because the serverless functions have no locality. In addition, orchestrating the scale up and out on functions (such as lambda functions) requires marshalling data feeds, and the engine leverages a storage-based mechanism to communicate between the workers and the driver.

For example, in a marketing technology application, audience analytics queries leveraging specialized data structures enable rapid statistical analysis such as histograms across large audience subsets without full data scans. As described above with respect to FIG. 3, the analytics engine provides multi-executor orchestration, also supporting both Kubernetes and cloud functions in a variety of VPCs. The analytics also can run in two tiers with cloud functions accessing a Kubernetes column cache. The analytics engine leverages a columnar metadata format, which speeds-up metadata processing (by avoiding footer scans) for highly partitioned Parquet tables with hundreds, thousands, or tens of thousands of columns. The analytics engine also provides other optimizations including data/metadata caching, row group pruning, and segmented vector column for efficient histograms. It provides the complex aggregation and statistical analysis required for different types of Big Data use cases, e.g., in a marketing application providing sub-second response times for audience segment analysis across billions of records and thousands of attributes. For this use case, the platform also leverages additional enhancements that are optimized for marketing analytics. These include a two-tier storage strategy that combines immutable row-oriented lakehouse data with query-optimized columnar data marts, audience-centric organization, wherein high volumes of subject event data are efficiently collated by high-cardinality identifiers to support audience analytics, and identity graph integration, wherein data marts are projected through identity graph “lenses” to create views representing different identity schemes (household, probabilistic merging, and the like). This Big Data use case is not limiting.

An embodiment of the platform may include both the processing engine and the analytics engine, or just one or the other.

The above-described techniques provide significant advantages. The combination of above-described innovations (including, without limitation, data-to-compute movement, a scale-up first approach, specialized primitives, and customized optimized file format libraries) results in a highly efficient, scalable, and adaptable framework suitable for modern big data processing challenges in cloud-based environments. As has been described, the design leverages multicore processors, cloud storage networks, efficient file formats, and the ability to create optimized complex primitives. This approach significantly outperforms traditional solutions (such as MapReduce-based frameworks), offering substantial improvements in processing speed, resource utilization, and overall efficiency for big data applications. Although not intended to be limiting, this framework achieves a significant (e.g., 16x+) reduction in gigabyte-seconds of resources for non-linear jobs, particularly those involving collations, sorts, and shuffles. The solution provides for 10-20× faster serverless queries at 50% lower cost, and the framework is optimized for data forward deployment and zero copy/data collaboration. It provides for open data storage (e.g. Avro/Parquet files on cloud object stores), and the framework may be implemented in association with a fully-managed deployment of storage and compute resources in a cloud compute environment, including a virtual private cloud (VPC). The solution also minimizes data silos and reduces latency, leading to improved operational efficiency, enhanced decision-making through timely insights, and scalable analytics pipelines capable of handling future data growth. The modular nature of the platform also enables customization for many types domain-specific applications including, without limitation, medical device telemetry, network security and financial transaction clearing, and many others.

The cloud-native shuffle mechanism described above provides further advantages. In this approach, and as has been described, event data to be processed is received by a first processing stage. Mapping operations on the event data are then performed using a plurality of executors. In lieu of transferring data between processing nodes, intermediate shuffle data is written directly to cloud object storage organized by partition keys. Reduce operations are then executed by reading the intermediate shuffle data from the cloud object storage into a second processing stage. In this way, the cloud object storage serves as a persistent shuffle medium enabling job recovery without re-execution of completed mapping tasks.

The techniques herein also provide for a cloud-native data processing system leveraging a plurality of compute nodes with configurable virtual cores, disaggregated cloud storage separate from the plurality of compute nodes, and high-bandwidth network connections between the plurality of compute nodes and the disaggregated cloud storage. In this approach, data processing is performed by streaming data from the cloud storage to the plurality of compute nodes on-demand rather than co-locating data with processing nodes. The compute nodes utilize parallel data streaming using lightweight concurrent threads to saturate available network bandwidth. In a preferred embodiment, further operational efficiencies are achieved by leveraging a GoLang-specific solution wherein data streaming utilizes GoLang goroutines for concurrent I/O operations, preferably with each goroutine consuming approximately just 2 KB of memory. This enables potentially hundreds of thousands of concurrent data streams per compute node. Further, these goroutines preferably communicate via channels for coordinating data processing tasks and without explicit thread locking mechanisms.

The approach herein also provides for highly-efficient data processing methods that identify data structure pattern in input datasets, and then select and execute specialized processing primitives based on these patterns using lightweight concurrent threads that process data directly from encoded formats and without deserialization overhead. The primitives include homogeneous collation primitives for single-key grouping operations, heterogeneous collation primitives for sort-merge join operations, and presorted merge primitives for globally-sorted timestamp data.

Additional advantages are realized using performance-optimized file format processing. This aspect is provided by the above-described techniques for processing columnar and row-based data formats. In particular, and according to the techniques herein, Avro records are treated as collation keys and remainder byte-strings, aggregation and join operations are performed on encoded data without decoding individual fields, output arrays are constructed by concatenating the encoded byte-strings, and GoLang libraries are optimized for zero-copy data operations and network-aligned serialization. Enabling technologies

Cloud computing is a model of service delivery for enabling on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Available services models that may be leveraged in whole or in part include: Software as a Service (Saas) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications). Typically, a cloud computing infrastructure may comprise co-located hardware and software resources, or resources that are physically, logically, virtually and/or geographically distinct. Communication networks used to communicate to and from the platform services may be packet-based, non-packet based, and secure or non-secure, or some combination thereof. Typically, the cloud computing environment has a set of high level functional components that include a front end identity manager, a business support services (BSS) function component, an operational support services (OSS) function component, and the compute cloud components themselves.

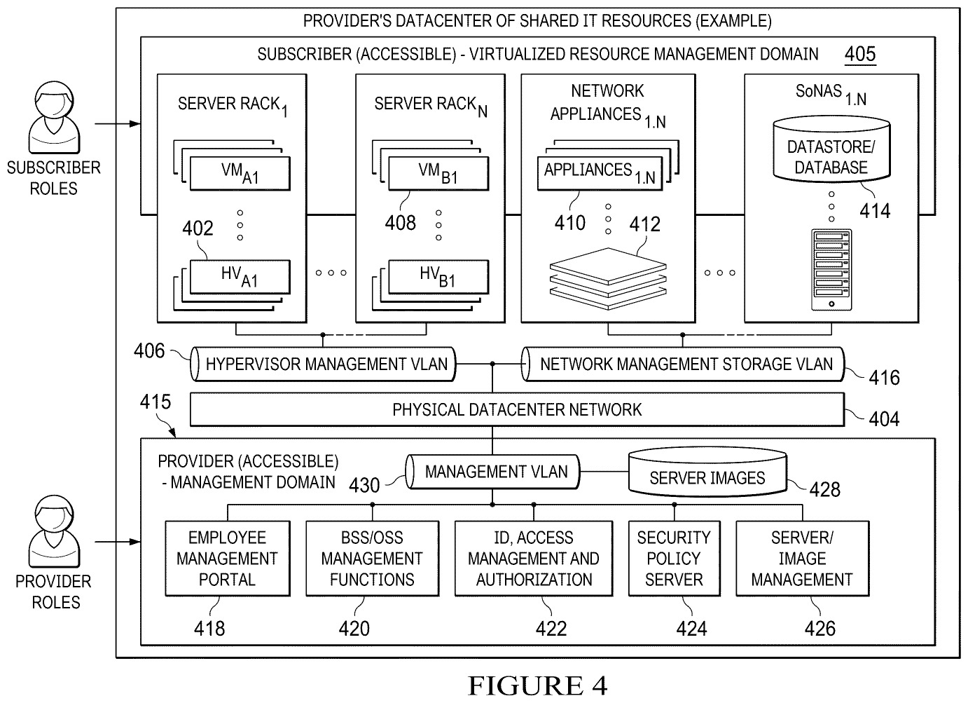

FIG. 4 depicts a cloud compute architecture in which the platform may be implemented. In FIG. 4, an example virtual machine hosting environment (alternately referred to herein as a data center or “cloud”) is illustrated. This environment comprises host machines (HVs) 402 (e.g., servers or like physical machine computing devices) connected to a physical datacenter network 404, typically via a hypervisor management VLAN 406. Typically, the environment also includes load balancers, network data switches (e.g., top-of-rack switches), firewalls, and the like. As shown in FIG. 4, physical servers 402 are each adapted to dynamically provide one or more virtual machines (VMs) 408 using virtualization technology. Server virtualization is a technique that is well-known in the art. As depicted, multiple VMs can be placed into a single host machine and share the host machine's CPU, memory and other resources, thereby increasing the utilization of an organization's data center. In this environment, tenant applications 410 are hosted in network appliances 412, and tenant data is stored in data stores and databases 414. The applications and data stores are connected to the physical datacenter network 404, typically via a network management/storage VLAN 416. Collectively, the virtual machines, applications and tenant data represent a subscriber-accessible virtualized resource management domain 405. Through this domain, the subscriber's employees may access and manage (using various role-based privileges) virtualized resources they have been allocated by the provider and that are backed by physical IT infrastructure. The bottom portion of the infrastructure illustrates a provider-accessible management domain 415. This domain comprises a provider employee management portal 418, BSS/OSS (Business Support Services/Operational Support Services) management functions 420, identity and access management functions 422, a security policy server 424, and management functions 426 to manage server images 428. These functions interface to the physical datacenter network via a management VLAN 430.

The cloud compute infrastructure may be augmented in whole or in part by one or more web servers, application servers, database services, and associated databases, data structures, and the like.

Aspects of this disclosure may be practiced, typically in software, on one or more machines or computing devices. More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, which provide the functionality of a given system or subsystem. As described, the functionality may be implemented in a standalone machine, or across a distributed set of machines. A computing device connects to the publicly-routable Internet, an intranet, a private network, or any combination thereof, depending on the desired implementation environment.

As noted above, one implementation may be a Big Data computing platform. One or more functions of the computing platform may be implemented in a cloud-based architecture. The platform may comprise co-located hardware and software resources, or resources that are physically, logically, virtually and/or geographically distinct. Communication networks used to communicate to and from the platform services may be packet-based, non-packet based, and secure or non-secure, or some combination thereof,

Each above-described process or process step/operation preferably is implemented in computer software as a set of program instructions executable in one or more processors, as a special-purpose machine.

Representative machines on which the subject matter herein is provided may be hardware processor-based computers running an operating system and one or more applications to carry out the described functionality. One or more of the processes described above are implemented as computer programs, namely, as a set of computer instructions, for performing the functionality described. Virtual machines may also be utilized.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject matter also relates to apparatus for performing the operations herein. This apparatus may be a particular machine that is specially constructed for the required purposes, or it may comprise a computer otherwise selectively activated or reconfigured by a computer program stored in the computer. Such a computer program may be stored in a non-transitory computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus.

There is no limitation on the type of computing entity that may implement a function or operation as described herein. Further, the identification of public cloud providers is not intended to be limiting.

While given components of the system have been described separately, one of ordinary skill will appreciate that some of the functions may be combined or shared in given instructions, program sequences, code portions, and the like. Any application or functionality described herein may be implemented as native code, by providing hooks into another application, by facilitating use of the mechanism as a plug-in, by linking to the mechanism, and the like.

The functionality may be co-located or various parts/components may be separately and run as distinct functions, and in one or more locations over a distributed network.

Computing entities herein may be independent from one another, or associated with one another. Multiple computing entities may be associated with a single enterprise entity, but are separate and distinct from one another. As noted above, a Big Data processing framework as described and depicted may be implemented within a cloud compute infrastructure (see, e.g., FIG. 4), or as an adjunct to one or more third party cloud compute infrastructures. In a preferred embodiment, and as depicted and described, the framework is implemented in whole or in part by a service provider on behalf of entities (e.g., enterprise customers) that use third party cloud computing resources. Portions of the processing framework may execute in an on-premises manner within or in association with an enterprise or a particular public cloud provider environment. As also described, the framework or processing components therein also comprises a web-accessible portal (e.g., an extranet application) that is accessible via a browser or mobile app via HTTP/HTTPS, or other protocol.

What is claimed here follows below:

1. A computing system operating in association with a cloud-based environment, comprising:
A compute layer implemented on hardware and software and configured with multi-executor orchestration to provide ingestion, transformation and collation of time-series event data, and;
a storage layer comprising a first data store, and a second data store, the first data store providing a system of record for harmonized data derived from the time-series event data, the harmonized data stored in an immutable, row-oriented data format, and the second data store providing an analytic environment and storing time-series event data in a column-oriented data format accessible utilizing columnar metadata; and
wherein multi-executor orchestration splits a workload into a series of tasks, assigns each task in the set of tasks to an executor of a set of executors, and receives and aggregates results from execution of the tasks by the set of executors.

2. The computing system as described in claim 1, wherein the row-oriented data format is Avro, and wherein the column-oriented data format is Parquet.

3. The computing system as described in claim 1, wherein the cloud-based environment comprises a set of compute nodes, and cloud storage, the set of compute nodes accessible via a set of network connections.

4. The computing system as described in claim 1, wherein transformation and collation of time-series event data occurs on a first compute node of the set of compute nodes following on-demand transfer of time-series event data from the first data store to the at least one compute node.

5. The computing system as described in claim 4, wherein the first compute node of the set of compute nodes is a host machine on which a given number of virtual cores are configurable for execution.

6. The computing system as described in claim 5, wherein an executor executes on a virtual core of the host machine.

7. The computing system as described in claim 5, wherein multi-executor orchestration scales up one or more virtual cores on the first compute node as necessary to execute the workload.

8. The computing system as described in claim 7, wherein multi-executor orchestration scales out to a second compute node when the given number of virtual cores in the first compute node are not sufficient to execute the workload.

9. The computing system as described in claim 1, wherein the multi-execution orchestration splits the workload across a swarm of serverless functions associated with the cloud-based environment.

10. The computing system as described in claim 1, wherein time-series event data is stored in a hybrid row-columnar format.

11. The computing system as described in claim 10, wherein the hybrid row-columnar format stores segmented embedded vectors.

12. The computing system as described in claim 2, wherein the columnar metadata is configured to bypass Parquet file format scanning.

13. The computing system as described in claim 3, wherein the cloud storage is co-located in a region with at least one node of the set of compute nodes.

14. A method of processing in association with a cloud compute infrastructure with network connections to a cloud storage, comprising:
receiving and storing in cloud storage a dataset, wherein row-oriented data in the dataset is stored for access according to a given row-based file format, and wherein column-oriented data in the dataset is stored for access according to a given column-based file format;
in response to receipt of a request to process a workload, moving at least a portion of the dataset to one or more compute nodes within the cloud compute infrastructure via the network connections; and
processing the request by splitting the workload into a set of tasks, assigning each task in the set of tasks to an executor of a set of executors, and receiving and aggregating results from execution of the tasks by the set of executors;
wherein processing includes at least one executor applying a data processing primitive that is one of: a homogeneous collation primitive, a heterogeneous collation primitive for sort-merge joins, a presorted record merge primitive, and a geospatial processing primitive.

15. The method as described in claim 14, wherein the given row-based file format is Avro, and the given column-based file format is Parquet.

16. The method as described in claim 14 wherein the primitive is one of a set of primitives, the set of primitives are implemented across the one or more compute nodes using concurrent threads executing up to thousands of concurrent tasks per compute node.

17. The method as described in claim 14, wherein data stored in the given row-based file format and given column-based file format are accessed according to requests that conform to a procedural object-oriented language.

18. The method as described in claim 17, wherein the procedural object-oriented language is GoLang, and wherein GoLang goroutines provide threads consuming less than ten (10) kilobytes of memory per thread to enable concurrent processing of data streams from the cloud storage without thread-switching overhead.

19. The method as described in claim 14, wherein the workload is processed on a swarm of serverless functions in the cloud compute infrastructure.

20. A method associated with a cloud-based infrastructure comprising a plurality of compute nodes, cloud storage distinct from the plurality of compute nodes, and network connections between the plurality of compute nodes and the cloud storage, the method comprising:
receiving event data to be processed by a first processing stage in the plurality of compute nodes;
mapping operations on the event data using a plurality of executors of a set of executors;
In lieu of transferring data between processing stages in the plurality of compute nodes, writing intermediate shuffle data generated by the plurality of executors directly to cloud object storage organized by one or more partition keys; and
executing reduce operations by reading the intermediate shuffle data from the cloud object storage into a second processing stage distinct from the first processing stage;
wherein the cloud object storage serves as a persistent shuffle medium enabling job recovery without re-execution of completed mapping tasks.
